(19) United States
(12) Patent Application Publication
(10) Pub. No.: US 2011/0082989 A1
(43) Pub. Date: Apr. 7, 2011

(54) STRUCTURE AND METHOD FOR MAKING A STORAGE CARD

(75) Inventors: Chih-Hung Wang, Yunlin County (TW); Chao-Hsiang Huang, Hsinchu County (TW)

(73) Assignee: Solid State System Co., Ltd., Hsinchu (TW)

(21) Appl. No.: 12/571,454

(22) Filed: Oct. 1, 2009

(51) Int. Cl. G06F 13/00; G06F 12/02

(52) U.S. Cl. 711/162; 711/173; 713/2; 711/E12.002

(57) ABSTRACT

A procedure for reproducing a storage card includes providing a preliminary storage card, wherein the preliminarily storage card has been partitioned into at least a first partitioned region and a second partitioned region and content has been written into the first partitioned region; providing a master storage card without being partitioned; copying the preliminary storage card with at least the first partitioned region and the second partitioned region into the master storage card based on the logic block addressing (LBA) mode, wherein the preliminary storage card is still not partitioned yet; and writing a signature into a DOS file system area of the first partitioned region at a specific signature area, wherein the signature includes a signature ID and a partition information corresponding to at least the first partitioned region and the second partitioned region in the preliminary storage card.

### BACKGROUND OF THE INVENTION

1. Field of Invention

The present invention relates to a storage card. More particularly, the present invention relates to a storage card with a content region and a public region.

2. Description of Related Art

A storage card for storing information has become rather popular to accommodate applications. For some applications that store information, the storage space of the storage card is partitioned into two disks. One disk of the storage space is, for example, for storing read only information. The other disk of the storage space is, for example, for public use to store the information freely available to the user. However, each time, in the conventional way only one disk is selected at a time to be accessed by the host.

FIG. 1 is a drawing, schematically illustrating conventional data in the storage card without partition. In FIG. 1, the storage card has a storage space 100, which usually has several sections 102. The sections are addressed by the logic block address (LBA). The storage capacity is 8 G in the example. The storage space 100 in this example is not partitioned into several disks, such as two disks. In this manner, the whole storage space 100 of 8 G is a single disk and all of storage space 100 in the storage card can be recognized by the host as a storage space 104 in the physical block address (PBA). When the host, such as a duplicator, wants to perform a process of disk copying, the whole storage space 100 can be copied to another storage card.

FIG. 2 is a drawing, schematically illustrating a conventional data partition for a storage card. In FIG. 2, the storage space 110 of the storage card is partitioned into two separated storage volumes, such as two disks with a storage space 112 of 6 G and a storage space 114 of 2 G, respectively. The controller in the storage card reports the information of just one of the two separated storage spaces 112 and 114 to the host. After switching to a selected one of the two storage space 112 and 114, the controller reports to host the information of the currently selected storage space.

A conventional duplicator can perform disk copying. It can copy the data in the source disk into the destination disk with LBA mode. Because the storage card in this example has been portioned into multiple disks or separate storages spaces 112 and 114, the duplicator cannot easily copy the whole data that is in the storage space 110 with LBA mode. For the storage cards which have been partitioned into multiple storage spaces, modifying the program on the duplicator with vendor commands is required to duplicate. This makes it not convenient for duplication.

However, in use it is quite common that the storage card is partitioned into multiple disks for various purposes. For example, the storage space 110 can be formatted by a DOS file system program and then be partitioned into the storages space 112 for use as a content region 102 and the storage space 114 for use as a public region. The content region 102 has been written with some information and is usually set with a security procedure to gain access when the user uses the storage card. The public region 114 allows the user to freely read and write information. The content region 112 usually needs a further security checking procedure to access the content.

As discussed in FIG. 2, when the storage card is partitioned into two disks, it is not easy to duplicate the whole storage card. On the other hand, for those storage cards which have been partitioned into multiple storage spaces, modifying the program on the duplicator with vendor commands is required to duplicate. This would also cause inconvenience to the user.

### SUMMARY OF THE INVENTION

The invention provides a procedure for producing a master storage card. The procedure comprises providing a first preliminary storage card. Then, the first preliminary storage card is portioned into at least a first partitioned region and a second partitioned region. A second preliminary storage card as a master storage card is provided. The first preliminary storage card is copied to the master storage card. A signature is written into an area of the master storage card, wherein the signature includes a partition information corresponding to at least the first partitioned region and the second partitioned region of the first preliminary storage card.

In an aspect of the invention, for example, the foregoing procedure further comprises writing a content data into the first partitioned region.

In an aspect of the invention, for example, the foregoing procedure further comprises setting the first partitioned region as a read-only region after writing the content data.

In an aspect of the invention, for example in the foregoing procedure, the content data an automatic switching program, if the automatic switching program has been run on a host side, it automatically switches a disk space to the public region after the master storage card is powered on.

In an aspect of the invention, for example in the foregoing procedure, the content data includes BIOS booting information and booting files, and it can serve as a bootable disk.

The invention also provides a procedure for reproducing a storage card. The procedure comprises providing a preliminary storage card as a slave storage card, wherein an internal firmware which will check the existence of the signature in the preliminary storage card is embedded; and providing a master storage card; and duplicating the master storage card into the slave storage card.

In an aspect of the invention, for example in the foregoing procedure, when the slave storage card is powered on for the first time, the internal firmware checks the existence of the signature and partitions the slave storage card into multiple storage spaces according to a partition information included in the signature.

The invention also provides a storage card, comprising a first storage region, for storing a content and a signature information and a second storage region for freely accessing by a user. The signature information stored in the first storage region includes a partition information of the first storage region and the second storage region.

In an aspect of the invention, for example in the foregoing storage card, the signature information is stored in a file system area in the first storage region.

In an aspect of the invention, for example in the foregoing storage card, the first storage region stores an automatic switching program, wherein if the automatic switching program has already been installed on a host side, the automatic switching program is executed by the host side to automatically switch a disk space to the public region after the storage card is powered on.

In an aspect of the invention, for example in the foregoing storage card, the first storage region stores an automatic switching program, wherein if the automatic switching program has not yet been installed on a host side, the automatic switching program is shown to the host side for an operation option after the storage card is powered on.

In an aspect of the invention, for example in the foregoing storage card, the first storage region stores a BIOS booting information and booting files so that the storage card serves as a bootable disk.

In an aspect of the invention, for example in the foregoing storage card, the first storage region is for read only.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating the LBA to PBA mapping of a conventional storage card without partitioned.

FIG. 2 is a drawing, schematically illustrating the LBA to PBA mapping of a conventional storage card with partitioned storage space.

FIG. 3 is a drawing, schematically illustrating a procedure to produce a storage card, which does not need a modifying vender command to duplicate the storage card with partitioned space, according to, an embodiment of the present invention.

FIG. 4 is a program diagram, implemented in the storage card at the content region for automatic switching.

### DESCRIPTION OF THE PREFERRED EMBODIMENTS

In the invention, a structure and procedure is proposed to make a storage card with a specific content region storing content information and a public region being free for use by the user. Embodiments are provided for describing the invention but not for restricting the invention.

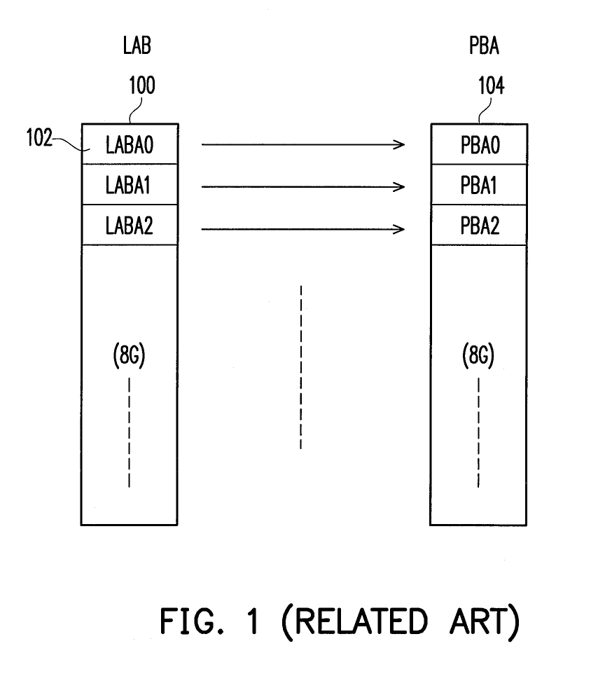

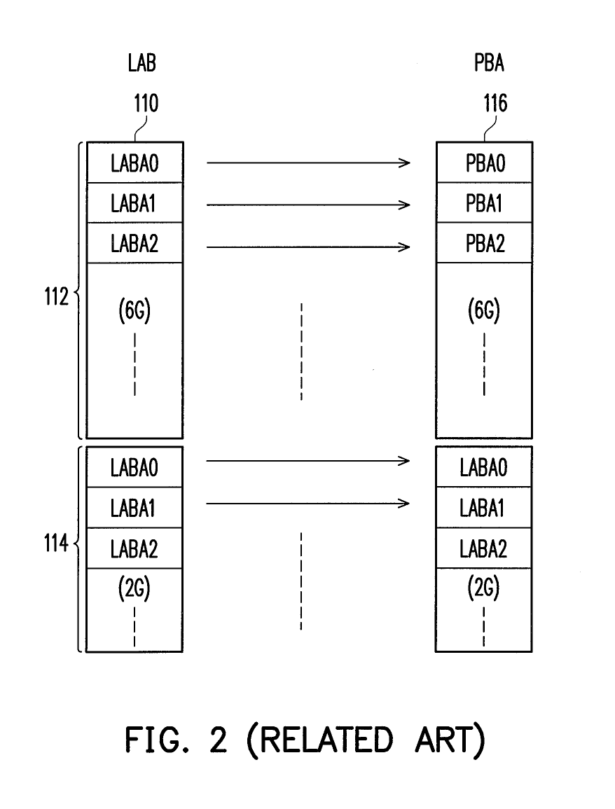

A host, like a personal computer, communicates with peripheral data storage devices based on a Logical Block Addressing scheme. The controller of the storage device maintains a mapping table of Logical Block Addresses (LBA) to Physical Block Addresses (PBA). FIG. 1 illustrates a storage card 100 of 8 G capacity that is not partitioned. FIG. 2 illustrates the LBA to PBA mapping of an 8 G storage card 110 which is partitioned into 6 G and 2 G After being partitioned, storage spaces 112 and 114 are not in the same disk space. The host must switch between storage space 112 and space 114 to access the data separately. To duplicate a storage card like 110 on a duplicator, one must add some vendor commands to switch to the other storage space to fully copy.

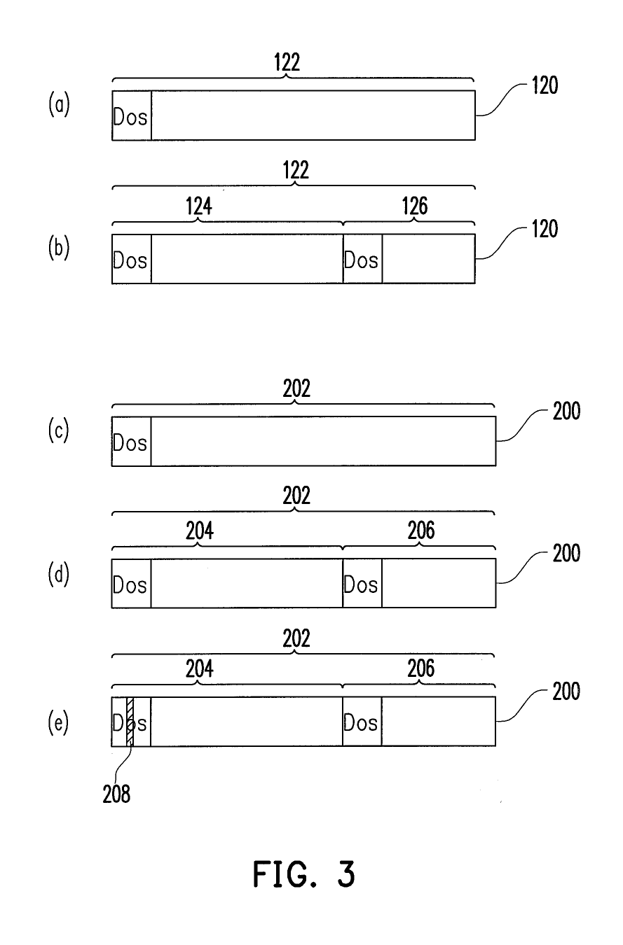

FIG. 3 is a drawing, schematically illustrating a procedure to produce a storage card, which does not require any proprietary vender commands for example, switching to other disk space on the duplicator to duplicate the storage card with partitioned space, according to an embodiment of the present invention.

In FIG. 3(a), a storage card 120 is first provided. The storage card 120 has been formatted into a single storage space 122 with the DOS file system information at the head region. Please be noted that the file system used in the invention is not limited to the DOS file system. Depending on the actual use, this storage card 120 can be any conventional storage card that hasn't been partitioned. In FIG. 3(b), the whole storage space of the storage card 120 of FIG. 3(a) is then partitioned into multiple storage spaces, such as two storage regions 124 and 126, by a conventional partition application program (AP), running at a host site.

The storage region 124 may be set as a read only region for storing content data, which is carried with the storage card and is not for free use. However, the storage 126 can be set as a public region for free access without restriction. In other words, the storages space 122 has been portioned into two storage regions 124 and 126 for different usage. The two storage regions 124 and 126 can be two separated disk spaces as is well known in the PC system. At the current stage, when the host is to access the storage card 120, vendor commands sending by an application program are required to switch between the storage regions 124 and 126. Each time when the host accesses the storage card 120, just one of the partitioned storage regions or disks is selected to be accessed.

However, when in the stage of duplicating the storage cards, since just one of the partitioned storage regions can be selected to be accessed in the host, such as a duplicator, as previously discussed, the conventional duplication process needs to switch to the storage regions one after one for copying. In addition, the vendor command needs to be modified to perform the above specific action, so as to fully duplicate the storage space 122 of the storage card 120.

The present invention proposes a novel process and structure of the storage card, so that the whole storage space with partitioned storage region can be easily copied and duplicated. An intermediate storage card named a master storage card is produced in the present invention. The master storage card can then be duplicated multiple times for end users. In FIG. 3(c), another storage card, called a master storage card 200, is also provided. The master storage card 200 in the initial stage is not partitioned. The storage space 202 is the whole available storage space of the storage card 200 while some DOS file system information is stored at the head region.

In FIG. 3(d), the storage space 122 with the two partitioned storage regions 124 and 126 shown in FIG. 3(b) are copied to the storage space 202 in FIG. 3(c) by an application program which can support both LBA mode and vendor command accesses. In other words, the master storage card 200 in this status is a copy from the storage space 122 of the storage card 120 in FIG. 3(b) in which the master storage card 200 is treated as a single disk for copying the information of the storage space 202. As a result, the stored information in the storage regions 204 and 206 is the same as the information in the storage regions 124 and 126. The storage region 204 later will be called a content region 204 which is portioned by DOS file system. The storage region 206 later will be called a public region 206 which is portioned by DOS file system as well.

Furthermore, in FIG. 3(e), a signature area 208 is written into a specific area, such as the area at LBA2 of DOS file system area of storage region 204 by the PC system. The signature area 208 has the partition information about the actual partition information for the storage regions 204 and 206 with respect to the storage card 120 in FIG. 3(b). The information stored in signature area 208 is listed in Table 1 and will be described later. The master storage card 200 in FIG. 3(e) becomes a finished master storage card 200 and can be copied to a slave storage card many times on a duplicator.

In the slave storage card, an internal firmware which is able to check and parse the information in signature area is embedded. When the slave storage card is powered on, the internal firmware will check the validity of the Signature ID. If the “Signature. ID” exists, the slave storage card will be partitioned into multiple storage regions according to the partition information.

TABLE 1

| Address | Offset | Bytes | Description |
|---|---|---|---|
| 0 | 63 | 64 | Signature ID |
| 64 | 67 | 4 | Total Storage Capacity |
| 68 | 71 | 4 | Starting Address of partition 0 |
| 72 | 75 | 4 | Capacity of the partition 0 |
| 76 | 79 | 4 | Starting Address of partition 1 |
| 80 | 83 | 4 | Capacity of the partition 1 |
| 84 | 87 | 4 | End of Signature |
| 88 | 511 | others | Reserved |

The partition information stored in the signature area 208 may include the information shown in Table 1 as an example. In Table 1, the signature in the signature area 208 includes, for example, Signature ID, Total Storage Capacity, Starting Address of partition 0, Capacity of the partition 0, Starting Address of partition 1, capacity of the partition 1, End of Signature, and Reserved. Total Storage Capacity refers to the storage capacity of the storage card. The partition 0 and partition 1 correspond to the two storage regions 204 and 206. If the number of storage regions is larger than two, the Starting Address and Capacity information of the later partitions can be added in succession. The partition information will end when End of Signature is reached.

After the slave storage card is powered on, the firmware is executed to detect whether or not the signature ID is correct. If the signature ID is not detected by the internal firmware, this storage card is still treated as a non-partition storage card. If the signature ID is indeed detected, the information of partition 0 and partition 1 are obtained by the firmware. The firmware will partition the storage card into the storage regions 204 and 206 according to the starting address and capacity information.

In addition, as previously mentioned, the storage region 204 may be set as a read only region. Some content is stored in the storage region 204, which may not be freely accessed and becomes a secure region. The storage region 204 can then be also referred to as the content region. In the content region, a vendor can also store some application specific software. The storage region 206 can then be free space for access, and is then called a public region, for example.

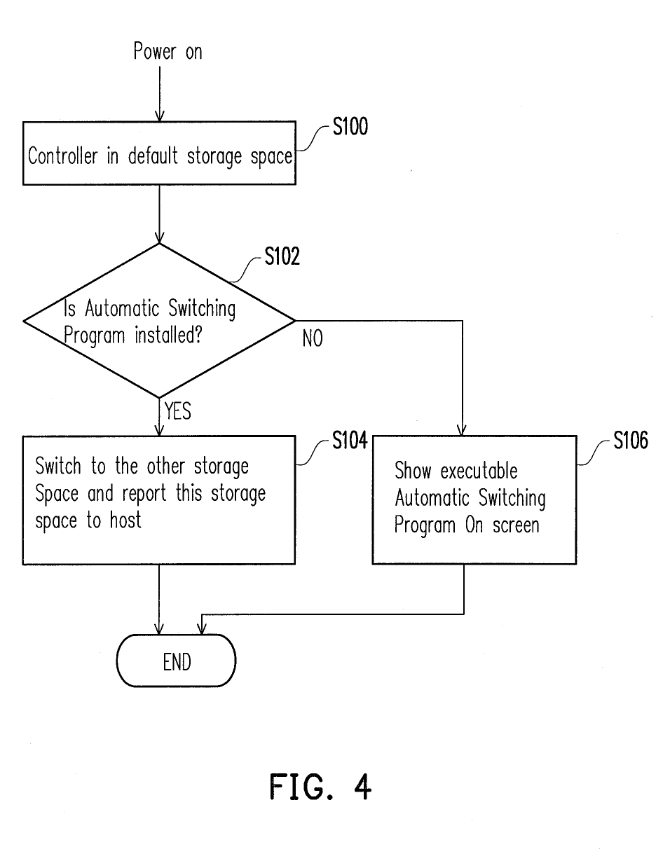

FIG. 4 is a flow chart of the application specific programs implemented in current invention. When the OS on PC is booted, known as PC power on, the slave storage card will log in the default storage space, for example, the storage region 204 in step S100. Further in step S102, it is checked whether or not the Automatic Switching Program has been installed by the user. If the automatic switching program has never been installed by the user, in step S106, the executable Automatic Switching Program in the content region 204 will be shown for the user to install. The controller also reports the default storage space to host. If the automatic switching program has been executed on the host in step S102, the controller will switch to the other storage space and report the current storage space to the host, in step S104. The host lets the default storage space be the content space and the other storage space be the public space. In such a case, if the Automatic Switching Program has been executed on the host, the controller will automatically switch the storage disk to the public space. It becomes a normal storage card for the user. The content card storing booting information and files in the content region can also serve for booting and recovering functions on the PC system. At the power on stage, if the BIOS bootable disk is set to the removable content card, the CPU will be booted and the files needed for rebooting the system will be loaded from the content region.

It can be also noted that additional applications can be added in accordance with the actual design. The example in FIG. 4 is not the only choice.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A procedure for producing a master storage card, the procedure comprising:
providing a first preliminary storage card;
partitioning the first preliminary storage card into at least a first partitioned region and a second partitioned region;
providing a second preliminary storage card as a master storage card;
copying the first preliminary storage card to the master storage card; and
writing a signature into an area of the master storage card, wherein the signature includes a partition information corresponding to at least the first partitioned region and the second partitioned region of the first preliminary storage card.

2. The procedure of claim 1, further comprising:
writing a content data into the first partitioned region.

3. The procedure of claim 2, further comprising:
setting the first partitioned region as a read-only region after writing the content data.

4. The procedure of claim 2, wherein the content data includes an automatic switching program, if the automatic switching program has been run on a host side, the automatic switching program automatically switches a disk space to the public region after the master storage card is powered on.

5. The procedure of claim 2, wherein the content data includes a BIOS booting information and booting files, so that the content data serve as a bootable disk.

6. A procedure for reproducing a storage card, the procedure comprising:
providing a preliminary storage card as a slave storage card, wherein an internal firmware which checks an existence of a signature in the preliminary storage card is embedded;
providing a master storage card; and
duplicating the master storage card into the slave storage card.

7. The procedure of claim 6, when the slave storage card is powered on for the first time, the internal firmware checks an existence of a signature and partitions the slave storage card into multiple storage spaces according to a partition information included in the signature.

8. A storage card, comprising:
a first storage region, for storing a content and a signature information; and
a second storage region, for freely accessing by a user,
wherein the signature information stored in the first storage region includes a partition information of the first storage region and the second storage region.

9. The storage card of claim 8, wherein the signature information is stored in a file system area in the first storage region.

10. The storage card of claim 8, wherein the first storage region stores an automatic switching program, wherein if the automatic switching program has already been installed on a host side, the automatic switching program is executed by the host side to automatically switch a disk space to the public region after the storage card is powered on.

11. The storage card of claim 8, wherein the first storage region stores an automatic switching program, wherein if the automatic switching program has not yet been installed on a host side, the automatic switching program is shown to the host side for an operation option after the storage card is powered on.

12. The storage card of claim 8, wherein the first storage region stores a BIOS booting information and booting files so that the storage card serves as a bootable disk.

13. The storage card of claim 8, wherein the first storage region is for read only.
